(19) United States
(12) Patent Application Publication
(10) Pub. No.: US 2017/0045641 A1
(43) Pub. Date: Feb. 16, 2017

(54) CORRECTING LOG DATA OF ARRAY INDUCTION TOOLS

(71) Applicant: Halliburton Energy Services, Inc., Houston, TX (US)

(72) Inventors: Ameet B. Agnihotri, Cypress, TX (US); Junsheng Hou, Kingwood, TX (US)

(73) Assignee: Halliburton Energy Services, Inc., Houston, TX (US)

(21) Appl. No.: 15/116,689

(22) PCT Filed: Feb. 9, 2016
(86) PCT No.: PCT/US2016/017142

§ 371 Date: Aug. 4, 2016

Related U.S. Application Data
(60) Provisional application No. 62/148,305, filed on Apr. 16, 2015.

(51) Int. Cl. G01V 13/00; G01V 3/10

(52) U.S. Cl. CPC G01V 13/00; G01V 3/10

(57) ABSTRACT

A system and method are described, such as for collecting borehole logging induction data with an induction logging tool. It may then be determined if the borehole logging induction data is within operating limitations of the logging tool. The operating limitations may be defined by a maximum diameter of the borehole at a predetermined mud resistivity. A borehole diameter threshold is determined that is within the operating limitations of the logging tool. When the diameter of the borehole is greater than the borehole diameter threshold, the borehole logging induction data is corrected based on executing an array induction job planner using the borehole diameter threshold at the predetermined mud resistivity.

### PRIORITY APPLICATION

This application claims the benefit of U.S. Provisional Application Ser. No. 62/148,305, filed on Apr. 16, 2015 which application is incorporated by reference herein in its entirety.

### BACKGROUND

Various techniques may be used to evaluate geological formations. For example, laterolog tools can use current and monitor electrodes to provide resistivity logging for a variety of relatively shallower or relatively deeper radial depths of investigation. Focusing of an injected current in the laterolog tool may be established using hardware or software techniques, or a combination of both hardware and software techniques. The laterolog device will work well in very saline borehole fluids with high formation resistivity whereas the same environment can be a problematic for Induction devices.

Certain measurement scenarios may still be problematic for array induction tool measurements. For example, difficult well logging conditions may result in inaccurate logging results due to higher contributions from the borehole signal. These difficult logging conditions may include the presence of high saline muds (or low resistivity muds), a relatively large borehole diameter, and/or relatively high formation resistivity.

### BRIEF DESCRIPTION OF THE DRAWINGS

FIG. 1 is a schematic diagram of an example array induction tool apparatus, according to aspects of the present disclosure.

FIG. 2 is a diagram of an array induction job planner, according to aspects of the present disclosure.

FIG. 3 is a flowchart of a method for data processing of measurements from the array induction tool apparatus, according to aspects of the present disclosure.

FIG. 4 is a diagram of a simulation of an array induction tool logging operation in a vertical borehole, according to aspects of the present disclosure.

FIG. 5 is a plurality of graphs of array induction tool logs at different frequencies, according to aspects of the present disclosure.

FIG. 6 is a plurality of graphs of array induction tool logs resulting from various corrections, according to aspects of the present disclosure.

FIG. 7 is a diagram showing a drilling system, according to aspects of the present disclosure.

FIG. 8 is a diagram showing a wireline system, according to aspects of the present disclosure.

FIG. 9 is a block diagram of an example system operable to implement the activities of any methods of the present disclosure, according to aspects of the present disclosure.

### DETAILED DESCRIPTION

Some of the challenges noted above, as well as others, can be addressed by implementing the apparatus, systems, and methods described herein. In many examples, apparatus and techniques are described for obtaining and correcting geological formation log data indicative of a formation resistivity using an array induction tool. Faulty log data that was obtained from a portion or all of the borehole outside of the operating limitations of an array induction logging tool may be corrected.

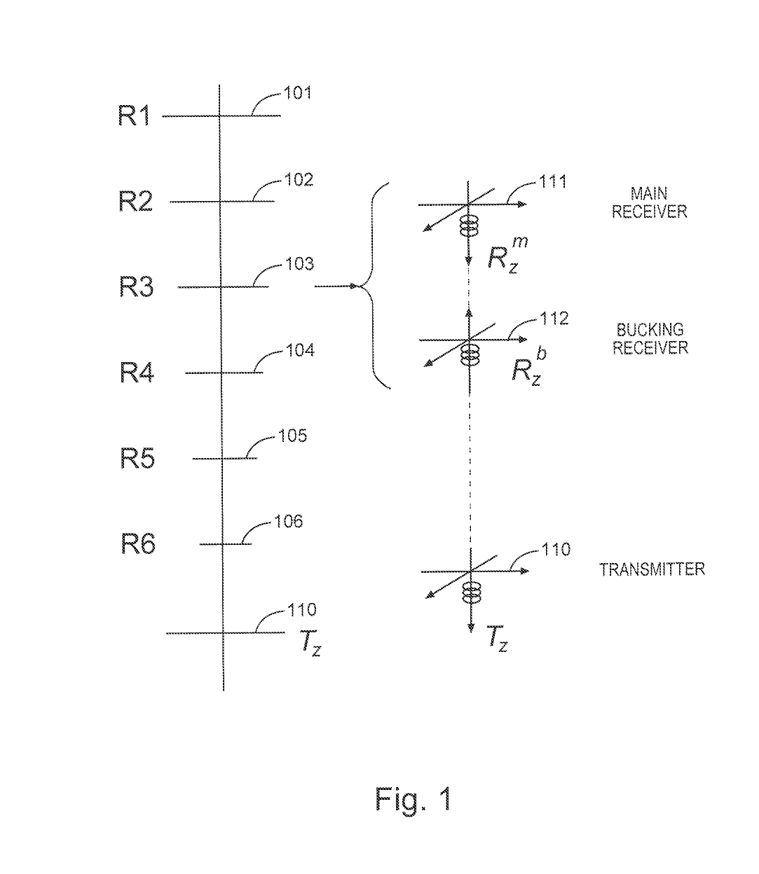

FIG. 1 is a schematic diagram of an example array induction logging tool apparatus 100, according to aspects of the present disclosure. The array induction logging tool apparatus 100 of FIG. 1 may be referred to as an array compensated resistivity sensor tool (ACRT) and is provided only for purposes of illustration of an example array induction tool. Other examples may use different laterolog logging tools.

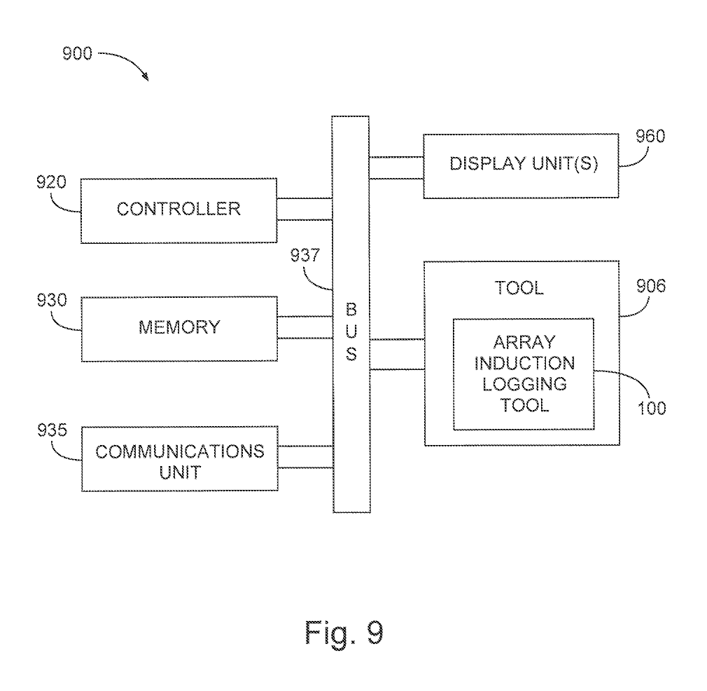

The array induction tool 100 may include a transmitter 110 and a plurality of receiver sub-arrays 101-106. Each receiver sub-array 101-106 may include a pair of receivers 111, 112 that may be referred to as a main receiver 111 and a bucking receiver 112. The array induction tool 100 may operate on a plurality of frequencies (e.g., 12 kilohertz (kHz), 36 kHz, 72 kHz) to allow for multiple frequency acquisition, quality check, noise control, and multi-frequency data processing. The transmitter 110 may transmit a signal, at one of the plurality of frequencies, into a geological formation. The plurality of receivers 101-106 may then receive a voltage signal that was induced in the receiver coils. The induced voltage signals being indicative of formation properties. The array induction tool apparatus 100 may further include circuitry as illustrated in FIG. 9 to control operation of the apparatus such as performing a logging operation. The circuitry may be separate from the transmitter and receiver portion of the tool and be configured to accept data indicative of the received signals and perform data processing methods for correcting inaccurate log data.

Array induction class logging tools, such as is illustrated in FIG. 1, provide for recording of formation resistivity. It may be realized that various borehole conditions (e.g., difficult logging conditions) may adversely affect the logging operation and result in corrupted logging data. For example, difficult logging conditions may include the presence of high saline muds (e.g., low resistivity muds), a relatively large borehole diameter, and/or relatively high formation resistivity.

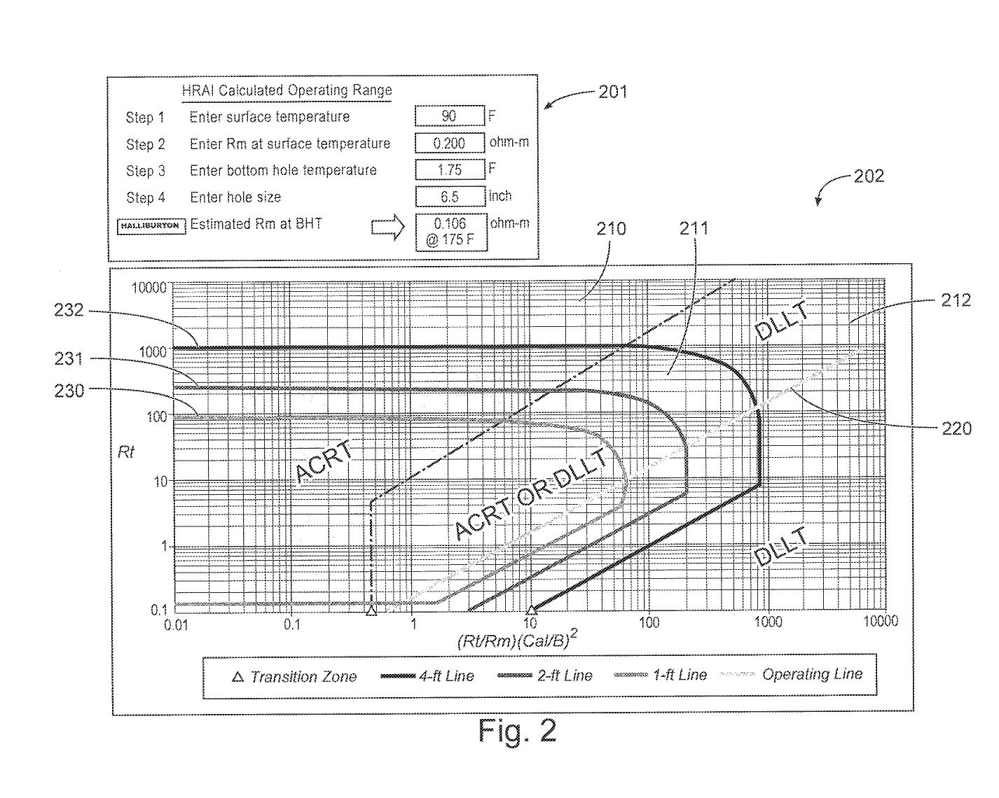

FIG. 2 is a diagram of an array induction job planner, according to aspects of the present disclosure. The illustrated planner may be used to determine whether logging results are adversely affected by difficult borehole conditions, thus resulting in inaccurate logging results. The job planner and the data entered into the input section 201 are for purposes of illustration only as other methods and other data may be used to determine whether logging results are bad.

The array induction job planner displays a vertical scale of the true resistivity (Rₜ) of the formation a distance away from the borehole where there are no invasive effects and a horizontal scale of the true resistivity (Rₜ) divided by the resistivity of the mud (Rₘ). The array induction job planner includes an input section 201 and an output section 202. The data entered into the input section 201 affects the movement of an operating line 220. The location of the operating line 220 within the different areas 210-212 of the graph determines the type of induction tool (e.g., ACRT) to be used based on the entered data 201.

The job planner further includes example vertical resolution contour lines 230-232 (e.g., 1 foot (ft.), 2 ft., 4 ft.) that provide indications of the areas 210-212 of the graph designated for each type of array induction tool.

As one example of operation of the job planner, a surface temperature of 90° F. was entered with a mud resistivity (Rₘ) of 0.200 Ohm-meter at that temperature. The bottom hole temperature was entered as 175° F. and the borehole size was entered as 6.5 inches. The operating line 220 resulting from this particular data input is shown to the left of the maximum vertical resolution line 232. Thus, the ACRT type of induction tool should produce accurate logging data. The data entered into the input section 201 is only to produce an example operating line 220 and does not limit the subject matter herein.

If, in another example, the resulting logging data were logged on the graph of FIG. 2 and it was plotted to the right of the operating line 220, that data would be considered inaccurate data. Thus, as used herein, inaccurate data may be defined as that data that is outside of the operating region of the selected induction tool.

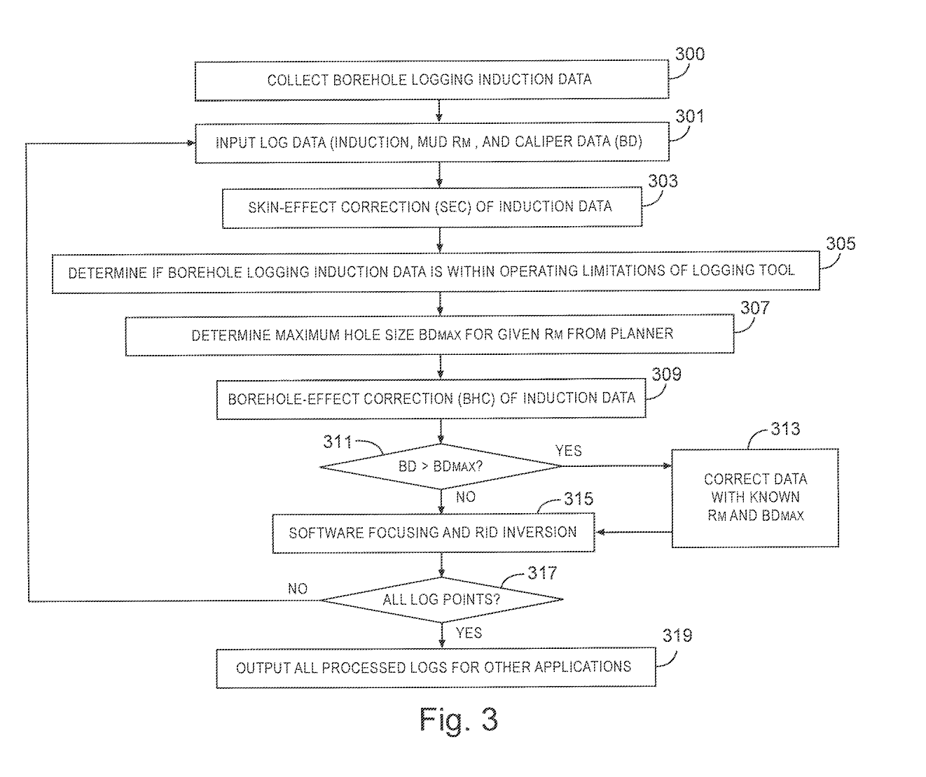

FIG. 3 is a flowchart of a method for data processing of measurements from the array induction tool apparatus, according to aspects of the present disclosure. The method assumes the use of and refers to the array induction job planner of FIG. 2. However, any other method for determining that the logging data is outside of the capabilities of the particular logging tool that performed the measurements (i.e., inaccurate logging data) may be used.

In block 300, borehole logging induction data is collected using the array induction tool 100. In block 301, the induction data, mud resistivity (Rₘ), and borehole diameter (B_{D}) (i.e., caliper data) are input to the array induction job planner. As described previously, this generates an operating limitation (i.e., operating line) for the selected type of induction tool based on the predetermined Rₘ and measured borehole diameter.

In block 303, a skin effect correction is performed on the logged induction data in order to remove any frequency effect from the logging induction data and thus improve the linearity. The skin effect may be defined as the loss in amplitude and change in phase of an electromagnetic field as it penetrates into a conductive medium. Thus, in an induction log, the skin effect causes a decrease of an R-signal (in-phase) and an increase in an X-signal (out-of-phase) at the receiver. Since the magnitude of the reduction depends on the conductivity, the skin effect may be corrected for by using a fixed function of the measured conductivity. The correction may be estimated from the X-signal measured in balanced arrays.

In block 305, the logged induction data is evaluated to determine if the borehole logged induction data, collected with a logging tool (e.g., array induction tool 100), is within the operating limitations of the logging tool that were generated based on a diameter of the borehole. This may be accomplished by determining the location of the logged induction data with reference to the operating line of the array induction job planner. This step determines if the logged induction data is good or bad by comparing the logged induction data to a resulting operating line from step 301 to determine if inaccurate logged induction data has been obtained. In an example, the logged induction data may be plotted on the induction array job planner graph to determine if the data is outside of the operating limitations of the induction tool (e.g., generating an operating line as an indication of the operating limitations of the logging tool).

In block 307, the maximum borehole diameter (B_{Dmax}) (e.g., borehole diameter threshold) is determined, within the operating limitations of the logging tool, for a given mud resistivity (Rₘ). This may be determined from the array induction job planner by increasing the borehole diameter input data (with a non-changing mud resistivity (Rₘ) and bottom hole temperature) until the operations line 220 moves to the line 232 representing the maximum vertical resolution (see FIG. 2). The borehole diameter that produces this alignment of operations line 220 and maximum vertical resolution line 232 (e.g., vertical resolution threshold) is the largest borehole diameter that can be used for logging and still obtain accurate logging induction data at that particular Rₘ and bottom hole temperature. The borehole diameter threshold is thus one parameter, at the particular Rₘ, that defines the operating limitations of the array induction tool 100.

In block 309, the borehole logged induction data is corrected for borehole-effect. The borehole-effect correction removes the borehole contribution to the logged induction data. The borehole-effect may be defined as the amount by which a log measurement is adjusted in order to remove the contribution of the borehole to the logged induction data. For example, raw coil signals are sent through skin-effect correction and then borehole-effect correction. Under ideal conditions, induction coils are reading the signal from their present position to infinity. Thus, a coil which is meant to measure data 80 inches from the coil and a coil that is meant to read 6 inches from the coil are both reading the information from their respective positions to infinity (moving out radially from the borehole). The first thing in the path of the transmitted signal is the borehole where there is conductive mud. Hence, a borehole-effect correction is used to correct (i.e., remove) the contribution of the mud from the signal for all of the various coils.

This correction may be effected by software or by manual entry into correction charts. In resistivity logging, the correction replaces the borehole with a resistivity equal to that of the formation.

In block 311, it is determined if the actual borehole diameter, used to generate the current logged induction data, is greater than the maximum allowable borehole diameter (B_{Dmax}) for a particular Rₘ and bottom hole temperature, as determined from above. If the actual, measured borehole diameter (B_{D}) is less than or equal to B_{Dmax}, then the logged induction data is probably good and normal processing continues at step 315.

When the measured borehole diameter B_{D} is greater than B_{Dmax}, the induction tool collected the logged induction data outside of its operating limitations and the logged induction data is considered bad. In this case, the borehole logging induction data is corrected based on the borehole diameter threshold, in block 313, using a known Rₘ and the B_{Dmax} diameter (i.e., borehole diameter threshold). The logged induction data is corrected to determine the skin-effect correction from the original data. In an example, the skin-effect correction refers to the values from 50 and 80 inch coils from the original data. The corrected data is re-logged using the borehole diameter threshold.

If the logged induction data was considered good or the inaccurate logged induction data has been reprocessed as described above, block 315 performs software focusing and radial one-dimensional inversion (R1D) on the corrected borehole induction data.

The software focusing refers to combining sub-array measurements into client deliverable curves. For example, a plurality of sets of vertical resolutions (e.g., 1 ft., 2 ft., 4 ft.) (see FIG. 2) wherein each set includes a plurality of penetration depths (e.g., 10, 20, 30, 60, 90 inches). This results in enhanced logged vertical resolution. The software focusing accomplishes vertically what was performed radially by the borehole-effect correction.

Block 317 then determines if all of the log points have been processed. If not, the processing repeats from block 301 as described previously. If all of the log points have been processed, the processed logs are then output for analysis by users or other software processing, in block 319.

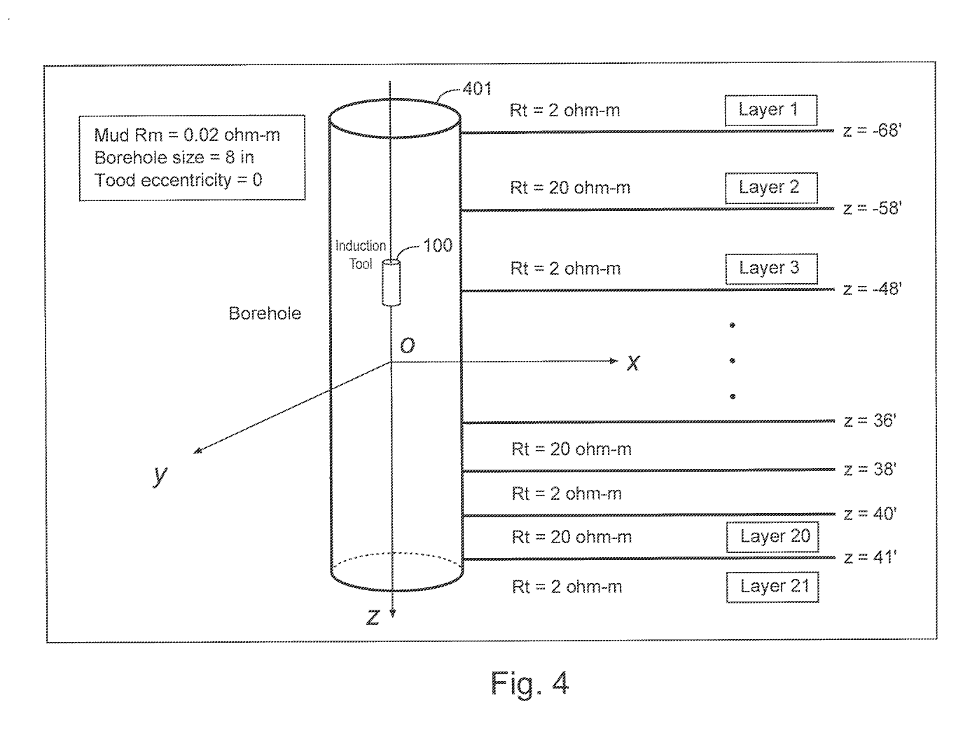

FIG. 4 is a diagram of a simulation of an array induction tool logging operation in a vertical borehole, according to aspects of the present disclosure. For purposes of illustration only, this simulation provides an example of an induction data logging operation and results of execution of the method of FIG. 3 on the logged induction data.

The simulation assumes the vertical borehole 401 of FIG. 4 that has a mud resistivity (Rₘ) of 0.02 ohm-m, a borehole diameter of 8 inches, and a tool eccentricity of zero. An induction logging tool 100 such as, for example, the tool of FIG. 1, is positioned in the borehole for the logging operation. Various formation layers (Layer 1-Layer 21) are shown at different z distances from an assumed reference point 0 in the borehole.

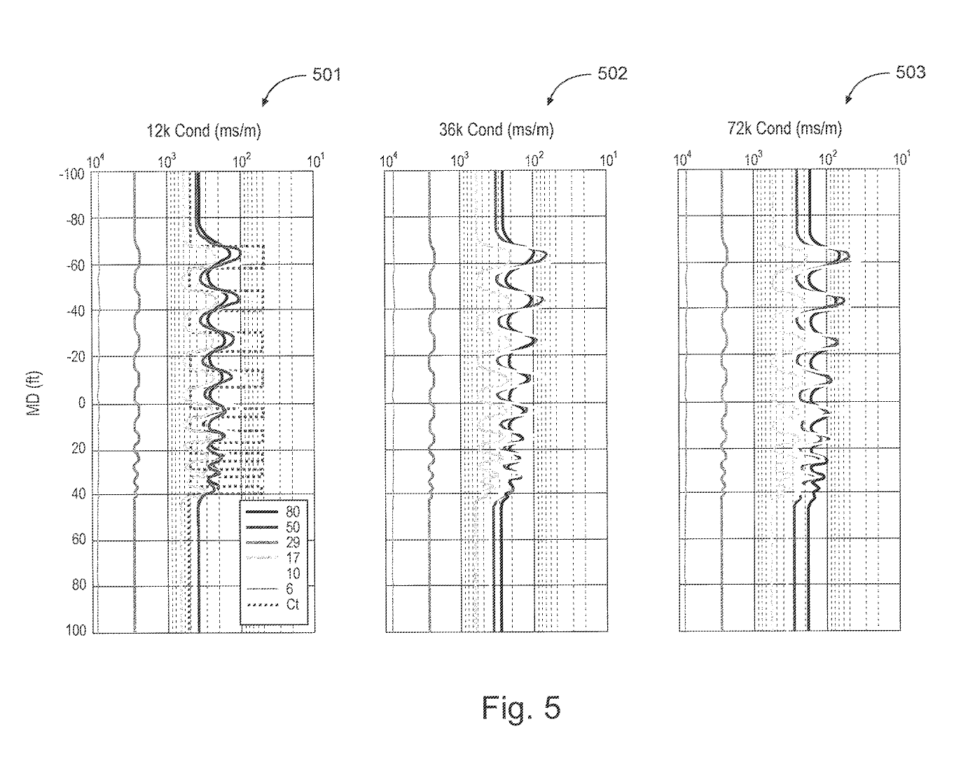

FIG. 5 is a plurality of graphs of array induction tool logs at different frequencies, according to aspects of the present disclosure. These array induction tool logs result from the simulation configuration illustrated in FIG. 4. It is assumed for purposes of this simulation, that six receiver arrays at three different frequencies were used in the tool 100 and that the true formation conductivity is represented by Cₜ. The various graphs have milliseconds per meter (ms/m) along the horizontal axis and measurement depth (MD) in feet (ft) along the vertical axis.

The first graph 501 shows the logged data at the first frequency of 12 kHz. The second graph 502 shows the logged data at the second frequency of 36 kHz. The third graph 503 shows the logged data at the third frequency of 72 kHz. These graphs illustrate the raw measurement data at each of those frequencies (i.e., 12 kHz, 36 kHz, and 72 kHz) and at the illustrated depths in the borehole.

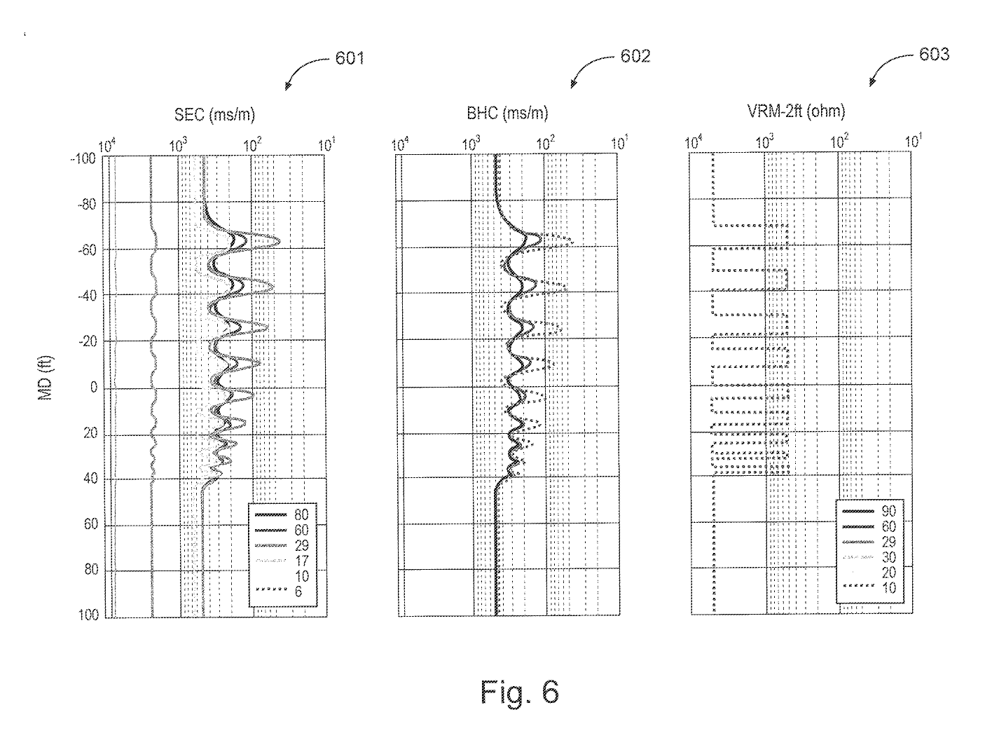

FIG. 6 is a plurality of graphs of array induction tool logs resulting from various corrections, according to aspects of the present disclosure. The first graph 601 shows the results of the skin-effect correction on the logged data. The second plot 602 shows the results of the borehole-effect correction on the logged data. The third plot 693 shows the final results of the method without evidence of any false invasion profile.

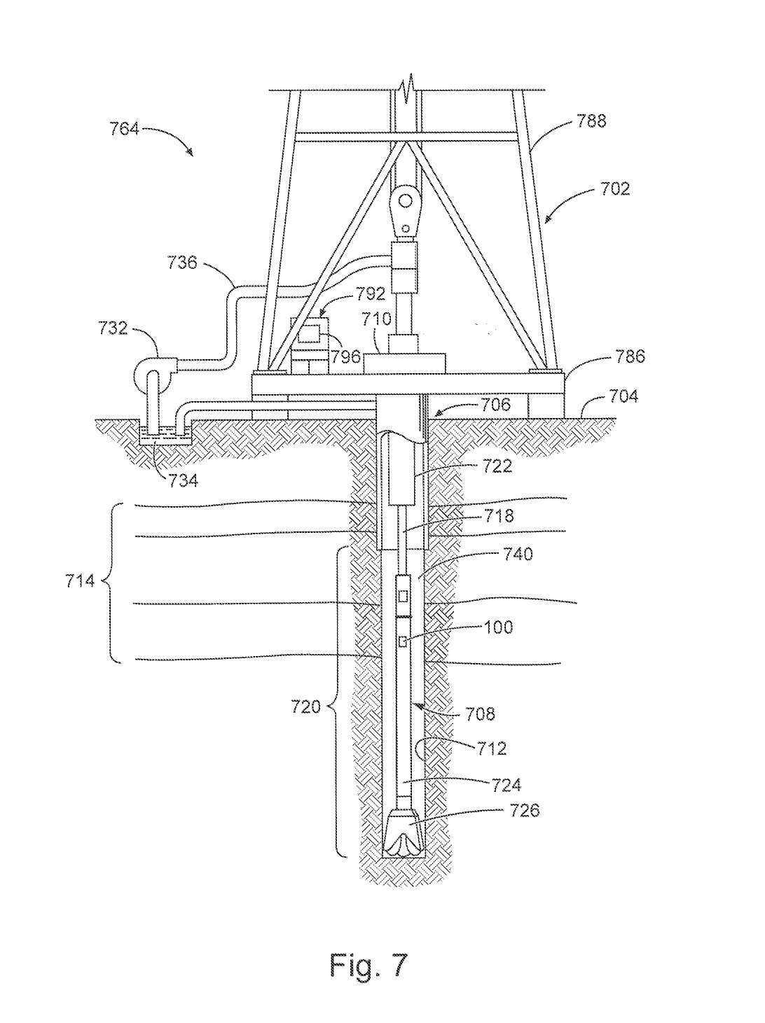

FIG. 7 is a diagram showing a drilling system 764, according to various examples of the disclosure. The system 764 includes a drilling rig 702 located at the surface 704 of a well 706. The drilling rig 702 may provide support for a drillstring 708. The drillstring 708 may operate to penetrate the rotary table 710 for drilling the borehole 712 through the subsurface formations 714. The drillstring 708 may include a drill pipe 718 and a bottom hole assembly (BHA) 720 (e.g., drill string), perhaps located at the lower portion of the drill pipe 718.

The BHA 720 may include drill collars 722, a down hole tool 724 including the array induction tool 100, and a drill bit 726. The drill bit 726 may operate to create the borehole 712 by penetrating the surface 704 and the subsurface formations 714. The downhole tool 724 may comprise any of a number of different types of tools besides the array induction tool 100. The array induction tool 100 may be used in measurement-while-drilling/logging-while-drilling (MWD/LWD) operations within the borehole 712. The array induction tool 100 used during the MWD/LWD operations may provide data to the surface (e.g., hardwired, telemetry).

During drilling operations within the borehole 712, the drillstring 708 (perhaps including the drill pipe 718 and the BHA 720) may be rotated by the rotary table 710. Although not shown, in addition to or alternatively, the BHA 720 may also be rotated by a motor (e.g., a mud motor) that is located down hole. The drill collars 722 may be used to add weight to the drill bit 726. The drill collars 722 may also operate to stiffen the bottom hole assembly 720, allowing the bottom hole assembly 720 to transfer the added weight to the drill bit 726, and in turn, to assist the drill bit 726 in penetrating the surface 704 and subsurface formations 714.

During drilling operations within the borehole 712, a mud pump 732 may pump drilling fluid (sometimes known by those of ordinary skill in the art as “drilling mud”) from a mud pit 734 through a hose 736 into the drill pipe 718 and down to the drill bit 726. The drilling fluid can flow out from the drill bit 726 and be returned to the surface 704 through an annular area 740 between the drill pipe 718 and the sides of the borehole 712. The drilling fluid may then be returned to the mud pit 734, where such fluid is filtered. In some examples, the drilling fluid can be used to cool the drill bit 726, as well as to provide lubrication for the drill bit 726 during drilling operations. Additionally, the drilling fluid may be used to remove subsurface formation cuttings created by operating the drill bit 726.

A workstation 792 including a controller 796 may include modules comprising hardware circuitry, a processor, and/or memory circuits that may store software program modules and objects, and/or firmware, and combinations thereof that are configured to execute the method of FIG. 3. The controller 796 may be configured to control operation of the array induction tool 100 in collecting data, performing skin-effect correction and borehole-effect correction of the induction data, software focusing and RID inversion, as well as determining whether the logged data is bad (i.e., inaccurate) and needs to be corrected according to the method of FIG. 3.

Thus, in various examples, components of a system operable can be realized in combinations of hardware and/or processor executed software. These implementations can include a machine-readable storage device having machine-executable instructions, such as a computer-readable storage device having computer-executable instructions. Further, a computer-readable storage device may be a physical device that stores data represented by a physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices.

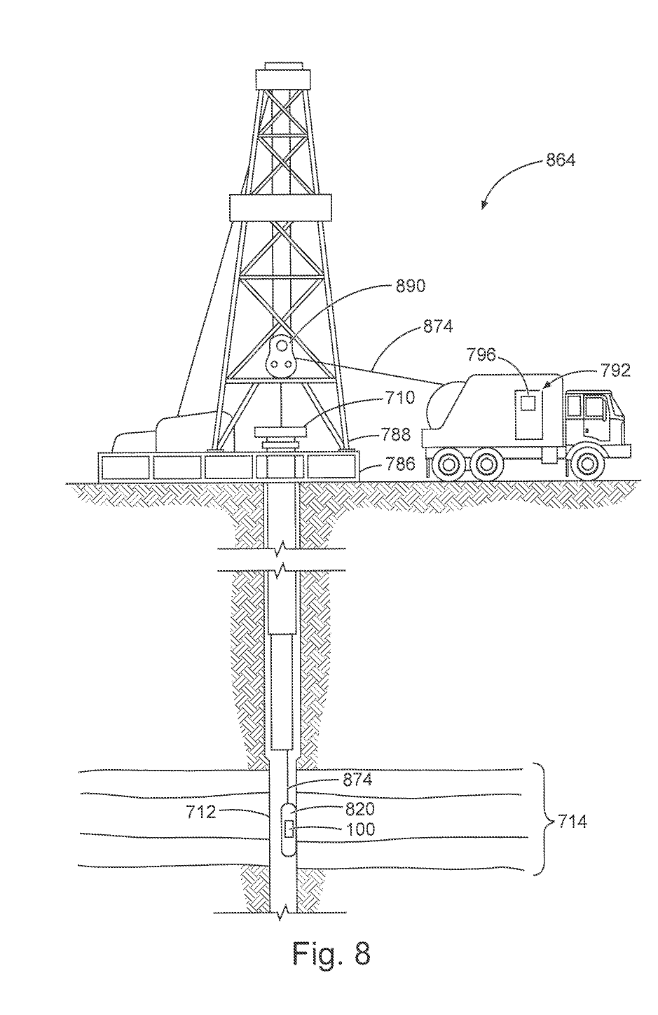

FIG. 8 is a diagram showing a wireline system 864, according to various examples of the disclosure. The system 864 may comprise a wireline logging tool body 820, as part of a wireline logging operation in a cased and cemented borehole 712, that includes the array induction tool 100 as described previously.

A drilling platform 786 equipped with a derrick 788 that supports a hoist 890 can be seen. Drilling oil and gas wells is commonly carried out using a string of drill pipes connected together so as to form a drillstring that is lowered through a rotary table 710 into the borehole 712. Here it is assumed that the drillstring has been temporarily removed from the borehole 712 to allow the wireline logging tool body 820, such as a probe or sonde with the array induction tool 100, to be lowered by wireline or logging cable 874 (e.g., slickline cable) into the borehole 712. Typically, the wireline logging tool body 820 with the array induction tool 100 is lowered to the bottom of the region of interest and subsequently pulled upward at a substantially constant speed.

During the upward trip, at a series of depths, various instruments may be used to perform geological formation measurements. The wireline data may be communicated to a surface logging facility (e.g., workstation 792) for processing, analysis, and/or storage. The logging facility 792 may be provided with electronic equipment for various types of signal processing as described previously. The workstation 792 may have a controller 796 that is coupled to the array induction tool 100 through the wireline 874 or telemetry in order to receive data from the logging tool regarding geological formation properties.

FIG. 9 is a block diagram of an example system 900 operable to implement the activities of any methods of the present disclosure, according to aspects of the present disclosure. The system 900 may include a tool housing 906 having the array induction tool 100, such as that illustrated in FIG. 1. The system 900 may be configured to operate in accordance with the teachings herein to perform geological formation measurements (i.e., logging operation) in order to determine the properties of the geological formation. The system 900 of FIG. 9 may be implemented as shown in FIGS. 7 and 8 with reference to the workstation 792 and controller 796.

The system 900 may include a controller 920, a memory 930, and a communications unit 935. The memory 930 may be structured to include a database. The controller 920, the memory 930, and the communications unit 935 may be arranged to operate as a processing unit to control operation of the array induction tool 100 and execute any methods disclosed herein.

The communications unit 935 may include downhole communications for appropriately located sensors in a wellbore. Such downhole communications can include a telemetry system. The communications unit 935 may use combinations of wired communication technologies and wireless technologies at frequencies that do not interfere with on-going measurements.

The system 900 may also include a bus 937, where the bus 937 provides electrical conductivity among the components of the system 900. The bus 937 can include an address bus, a data bus, and a control bus, each independently configured or in an integrated format. The bus 937 may be realized using a number of different communication mediums that allows for the distribution of components of the system 900. The bus 937 may include a network. Use of the bus 937 may be regulated by the controller 920.

The system 900 may include display unit(s) 960 as a distributed component on the surface of a wellbore, which may be used with instructions stored in the memory 930 to implement a user interface to monitor the operation of the tool 906 or components distributed within the system 900. The user interface may be used to input parameter values for thresholds such that the system 900 can operate autonomously substantially without user intervention in a variety of applications. The user interface may also provide for manual override and change of control of the system 900 to a user. Such a user interface may be operated in conjunction with the communications unit 935 and the bus 937. Many examples may thus be realized. A few examples of such examples will now be described.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

### Embodiments

Example 1 is a method comprising: determining if borehole logging induction data collected with a logging tool is within operating limitations of the logging tool generated based on a diameter of the borehole; determining a borehole diameter threshold within the operating limitations of the logging tool; and when the diameter of the borehole is greater than the borehole diameter threshold, correcting the borehole logging induction data based on the borehole diameter threshold.

In Example 2, the subject matter of Example 1 can further include wherein correcting the borehole logging induction data based on the borehole diameter threshold comprises correcting the borehole logging induction data based on the borehole diameter threshold at a predetermined mud resistivity.

In Example 3, the subject matter of Examples 1-2 can further include wherein determining if the borehole logging induction data is within the operating limitations of the logging tool generated based on the diameter of the borehole comprises executing an induction array job planner.

In Example 4, the subject matter of Examples 1-2 can further include wherein executing the induction array job planner comprises generating an operating line as an indication of the operating limitations of the logging tool.

In Example 5, the subject matter of Examples 1-2 can further include wherein generating the operating line comprises generating the operating line based on a predetermined mud resistivity and the diameter of the borehole.

In Example 6, the subject matter of Examples 1-2 can further include wherein determining the borehole diameter threshold comprises executing the array job planner with an increasing borehole diameter until the operating line is aligned with a vertical resolution threshold.

In Example 7, the subject matter of Examples 1-2 can further include correcting the borehole logging induction data based on a skin-effect correction; and correcting the borehole logging induction data based on a borehole-effect correction.

In Example 8, the subject matter of Examples 1-2 can further include performing software focusing on the corrected borehole induction data; and performing radial inside diameter inversion of the corrected borehole induction data.

Example 9 is a non-transitory computer-readable storage medium that stores instructions for execution by one or more processors to perform logging operations, the operations comprising: determine if borehole logging induction data is within operating limitations of a logging tool, the borehole logging induction data generated based on a diameter of the borehole; determine a borehole diameter threshold of the borehole such that an operations line is within the operating limitations; and when the diameter of the borehole is greater than the borehole diameter threshold, correct the borehole logging induction data based on the borehole diameter threshold at a predetermined mud resistivity.

In Example 10, the subject matter of Example 9 can further include wherein the operations further comprise the execution of an induction array job planner to determine if the borehole logging induction data is within the operating limitations of the logging tool.

In Example 11, the subject matter of Examples 9-10 can further include wherein the operations further generate the operations line by execution of the induction array job planner based on a vertical resolution limit of the logging tool.

In Example 12, the subject matter of Examples 9-11 can further include wherein the operations execute the induction array job planner by increasing the borehole diameter until the operations line is substantially aligned with the vertical resolution limit.

In Example 13, the subject matter of Examples 9-12 can further include wherein the operations further define the operating limitations of the apparatus based on the borehole diameter threshold at the predetermined mud resistivity and a predetermined surface temperature.

Example 14 is a system comprising: an induction logging tool to be disposed in a borehole and generate logging data indicative of geological formation properties; and circuitry coupled to the induction logging tool to accept the logging data from the induction logging tool, determine if the logging data is within operating limitations of the induction logging tool based on a diameter of the borehole, determine a borehole diameter threshold indicative of the operating limitations, and when the borehole diameter is greater than the borehole diameter threshold, the circuitry is to correct the logging data based on the borehole diameter threshold at a predetermined mud resistivity.

In Example 15, the subject matter of Example 14 can further include wherein the system further comprises a drill string and the induction logging tool is disposed in the drill string.

In Example 16, the subject matter of Examples 14-15 can further include wherein the system further comprises a wireline tool and the induction logging tool is disposed in the wireline tool.

In Example 17, the subject matter of Examples 14-16 can further include wherein the induction logging tool is a laterolog class tool.

In Example 18, the subject matter of Examples 14-17 can further include wherein the circuitry is further to: perform skin-effect correction of the logging data; perform borehole-effect correction of the logging data; and perform software focusing of the logging data.

In Example 19, the subject matter of Examples 14-18 can further include wherein the circuitry executes an array induction job planner to determine the operating limitations.

In Example 20, the subject matter of Examples 14-19 can further include wherein the circuitry executes the array induction job planner by increasing the borehole diameter at the predetermined mud resistivity until an operations line is substantially aligned with a vertical resolution limit of the induction logging tool.

This disclosure is intended to cover any and all adaptations or variations of various embodiments. Combinations of the above embodiments, and other embodiments not specifically described herein, will be apparent to those of skill in the art upon reviewing the above description.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
determining if borehole logging induction data collected with a logging tool is within operating limitations of the logging tool generated based on a diameter of the borehole;
determining a borehole diameter threshold within the operating limitations of the logging tool; and
when the diameter of the borehole is greater than the borehole diameter threshold, correcting the borehole logging induction data based on the borehole diameter threshold.

2. The method of claim 1, wherein correcting the borehole logging induction data based on the borehole diameter threshold comprises correcting the borehole logging induction data based on the borehole diameter threshold at a predetermined mud resistivity.

3. The method of claim 1, wherein determining if the borehole logging induction data is within the operating limitations of the logging tool generated based on the diameter of the borehole comprises executing an induction array job planner.

4. The method of claim 3, wherein executing the induction array job planner comprises generating an operating line as an indication of the operating limitations of the logging tool.

5. The method of claim 4, wherein generating the operating line comprises generating the operating line based on a predetermined mud resistivity and the diameter of the borehole.

6. The method of claim 4, wherein determining the borehole diameter threshold comprises executing the array job planner with an increasing borehole diameter until the operating line is aligned with a vertical resolution threshold.

7. The method of claim 1, further comprising:
correcting the borehole logging induction data based on a skin-effect correction; and
correcting the borehole logging induction data based on a borehole-effect correction.

8. The method of claim 7, further comprising:
performing software focusing on the corrected borehole induction data; and
performing radial one-dimensional inversion of the corrected borehole induction data.

9. A non-transitory computer-readable storage medium that stores instructions for execution by one or more processors to perform logging operations, the operations:
determine if borehole logging induction data is within operating limitations of a logging tool, the borehole logging induction data generated based on a diameter of the borehole;
determine a borehole diameter threshold of the borehole such that an operations line is within the operating limitations; and
when the diameter of the borehole is greater than the borehole diameter threshold, correct the borehole logging induction data based on the borehole diameter threshold at a predetermined mud resistivity.

10. The non-transitory computer-readable storage medium of claim 9, wherein the operations further comprise the execution of an induction array job planner to determine if the borehole logging induction data is within the operating limitations of the logging tool.

11. The non-transitory computer-readable storage medium of claim 10, wherein the operations further generate the operations line by execution of the induction array job planner based on a vertical resolution limit of the logging tool.

12. The non-transitory computer-readable storage medium of claim 11, wherein the operations execute the induction array job planner by increasing the borehole diameter until the operations line is substantially aligned with the vertical resolution limit.

13. The non-transitory computer-readable storage medium of claim 9, wherein the operations further define the operating limitations of the apparatus based on the borehole diameter threshold at the predetermined mud resistivity and a predetermined surface temperature.

14. A system comprising:
an induction logging tool to be disposed in a borehole and generate logging data indicative of geological formation properties; and
circuitry coupled to the induction logging tool to accept the logging data from the induction logging tool, determine if the logging data is within operating limitations of the induction logging tool based on a diameter of the borehole, determine a borehole diameter threshold indicative of the operating limitations, and when the borehole diameter is greater than the borehole diameter threshold, the circuitry is to correct the logging data based on the borehole diameter threshold at a predetermined mud resistivity.

15. The system of claim 14, wherein the system further comprises a drill string and the induction logging tool is disposed in the drill string.

16. The system of claim 14, wherein the system further comprises a wireline tool and the induction logging tool is disposed in the wireline tool.

17. The system of claim 14, wherein the induction logging tool is a laterolog class tool.

18. The system of claim 14, wherein the circuitry is further configured to:
perform skin-effect correction of the logging data;
perform borehole-effect correction of the logging data; and
perform software focusing of the logging data.

19. The system of claim 14, wherein the circuitry executes an array induction job planner to determine the operating limitations.

20. The system of claim 19, wherein the circuitry executes the array induction job planner by increasing the borehole diameter at the predetermined mud resistivity until an operations line is substantially aligned with a vertical resolution limit of the induction logging tool.
